(19) United States
(12) Patent Application Publication
(10) Pub. No.: US 2025/0250473 A1
(43) Pub. Date: Aug. 7, 2025

(54) METHOD OF FORMULATING AN ACTIVE ICE-REPULSING NANO-FILLED COATING

(71) Applicant: Raytheon Company, Arlington, VA (US)

(72) Inventors: Danielle L. Grolman, Holden, MA (US); Wenping Zhao, Glastonbury, CT (US); Laura A. Cuthbert, Austin, TX (US); Derrick J. Rockosi, Lynn, MA (US); Mary K. Herndon, Littleton, MA (US); Peter J. Walsh, Wethersfield, CT (US)

(21) Appl. No.: 19/092,264

(22) Filed: Mar. 27, 2025

Related U.S. Application Data
(63) Continuation-in-part of application No. 18/129,506, filed on Mar. 31, 2023.

(51) Int. Cl. C09K 3/18; C09D 1/00; C09D 7/40; H01Q 1/02; H01Q 1/42

(52) U.S. Cl. CPC C09K 3/18; C09D 1/00; C09D 7/67; C09D 7/68; H01Q 1/02; H01Q 1/42

(57) ABSTRACT

A radome surface coating arrangement transparent to radiofrequency (RF) signals, the coating arrangement includes a first coating layer applied to and in physical contact with a radome surface and a second coating layer applied to and in physical contact with the first coating layer. The first coating layer includes nanoparticles capable of being heated by RF signals emitted through the coating arrangement. The second coating layer is a hydrophobic or superhydrophobic coating material devoid of the nanoparticles. The second coating layer covers the first coating layer.

### CROSS-REFERENCE TO RELATED APPLICATION(S)

This application is a continuation-in-part of U.S. application Ser. No. 18/129,506 filed Mar. 31, 2023, for “METHOD OF FORMULATING AN ACTIVE ICE-REPULSING NANO-FILLED COATING” by D. Grolman, W. Zhao, L. Cuthbert, D. Rockosi, M. Herndon, and P. Walsh.

### BACKGROUND

The present disclosure relates generally to protective enclosures for electronic equipment, and more particularly, to anti-icing coatings thereupon.

Radar systems often use arrays of electronic instruments for tracking, guidance, and targeting. Such systems often use electromagnetically transparent covers (i.e., radomes) to protect the instruments. It has been observed that ice formation and accumulation on radome surfaces can result in significant radiofrequency (RF) interference which can have a critical, adverse effect on the system performance and operation. Thus, means for mitigating ice formation are desirable.

### SUMMARY

In one aspect, an article transparent to radiofrequency (RF) signals includes a substrate and a coating arrangement on the substrate. The coating arrangement includes a primer applied to and in physical contact with the substrate, a topcoat applied to and in physical contact with the primer layer, the topcoat including an organic polymer material, and nanoparticles dispersed throughout one of the primer and the topcoat. A content of the nanoparticles ranges from 0.05 wt % to 5 wt %.

In another aspect, a method of preventing ice formation on a radome includes applying a coating arrangement to a surface of the radome. The coating arrangement includes a primer applied to and in physical contact with the surface of the radome, a topcoat applied to and in physical contact with the primer layer, the topcoat including an organic polymer material, and nanoparticles dispersed throughout one of the primer and the topcoat. The method further includes operating an instrument at least partially surrounded by the radome to emit radiofrequency (RF) signals such that the heating of the nanoparticles is induced by the RF signals.

In yet another aspect, an article transparent to radiofrequency (RF) signals includes a substrate and a coating arrangement on the substrate. The coating arrangement includes a first coating layer applied to and in physical contact with the substrate and a second coating layer applied to and in physical contact with the first coating layer. The first coating layer includes a hydrophobic or superhydrophobic coating material and nanoparticles dispersed throughout the hydrophobic or superhydrophobic coating material. The nanoparticles are capable of being heated by RF signals emitted through the substrate. The second coating layer includes the hydrophobic or superhydrophobic coating material of the first coating layer but is devoid of the nanoparticles. The second coating layer covers the first coating layer. In some aspects, the second coating layer can visually conceal the first coating layer, and in some aspects can at least conceal the first coating layer form the naked eye.

In yet another aspect, a method of preventing ice formation on a radome includes applying a coating arrangement to a surface of the radome and operating an instrument at least partially surrounded by the radome to emit RF signals. The coating arrangement includes a first coating layer applied to and in physical contact with the substrate and a second coating layer applied to and in physical contact with the first coating layer. The first coating layer includes a hydrophobic or superhydrophobic coating material and nanoparticles dispersed throughout the hydrophobic or superhydrophobic coating material. The nanoparticles are capable of being heated by RF signals emitted through the substrate. The second coating layer includes the hydrophobic or superhydrophobic coating material of the first coating layer but is devoid of the nanoparticles. Heating of the nanoparticles is induced by the RF signals.

The present summary is provided only by way of example, and not limitation. Other aspects of the present disclosure will be appreciated in view of the entirety of the present disclosure, including the entire text, claims and accompanying figures.

### BRIEF DESCRIPTION OF THE DRAWINGS

FIG. 1 is a schematic illustration of an RF-emitting system including a radome.

FIGS. 2A-2C are simplified cross-sectional illustrations of alternative ice-protection coatings for a radome.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

This disclosure presents an ice-protection coating arrangement for a radome surface. The coating arrangement includes heat-generating nanoparticles in either the outer topcoat layer or the underlying primer layer. RF signals from the incorporating system (e.g., radar system) induce heating of the nanoparticles which sufficiently heat the radome to prevent ice formation. The nanoparticle content selected is sufficient to generate enough heat while maintaining the RF transparency of the radome. The nanoparticles do not significantly increase the weight of the coating arrangement, and do not require a separate/dedicated source of power or other stimulus to generate heat. The addition of nanoparticles do not significantly impact the overall radar performance or RF properties in the operating bands.

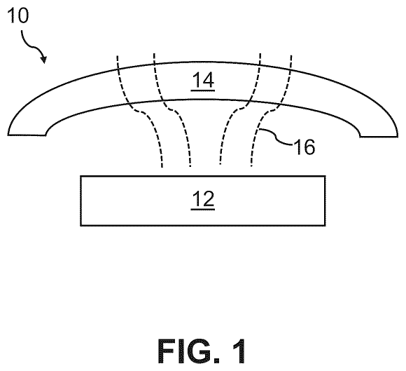

FIG. 1 is a schematic illustration of system 10 which emits RF signals. In an exemplary embodiment, system 10 can be a terrestrial or vehicle-borne radar system having RF-emitting instrument 12 (e.g., antenna array) and protective radome 14 at least partially surrounding instrument 12. Radome 14 protects instrument 12 from environmental factors (e.g., moisture, weather, debris, etc.) while remaining transparent to RF signal emanations 16.

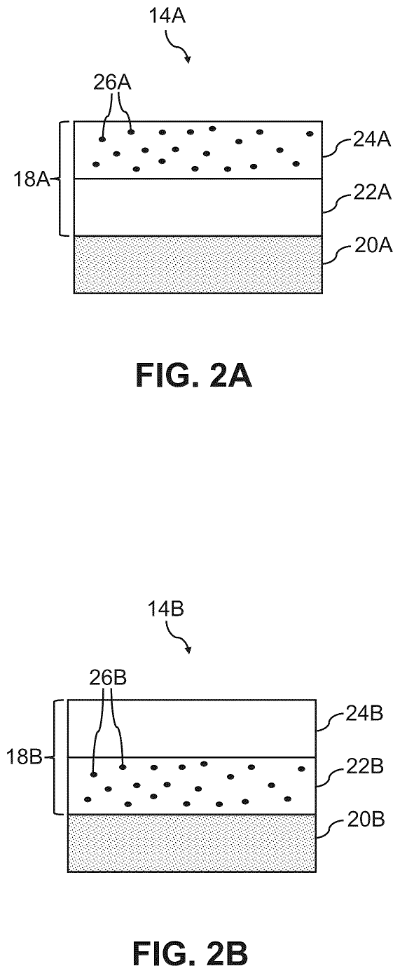

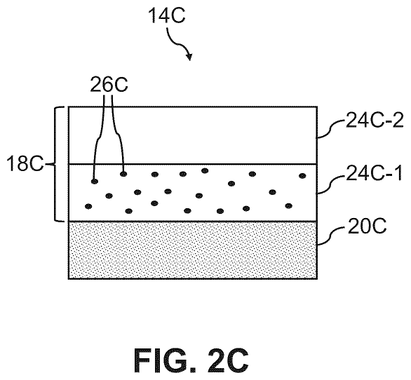

FIGS. 2A-2C are simplified cross-sectional illustrations of portions of radomes 14A-14C, respectively, with alternative nanoparticle-based coating arrangements. More specifically, FIG. 2A illustrates coating arrangement 18A on substrate 20A. Substrate 20A can be the outermost surface of a radome 14A receiving coating arrangement 20A. Substrate 20A can be a composite, such as cyanate ester quartz, epoxy glass, or pre-preg foam. Coating arrangement 18A can include primer 22A (first coating layer) applied to substrate 20A, and topcoat 24A (second coating layer) applied to primer 22A. In one embodiment, primer 22A can be a Mil-Spec epoxy or urethane primer, although other types of primers are contemplated herein. Topcoat 24A can be a hydrophobic or superhydrophobic organic polymer coating. Specifically, topcoat 24A can be a hydrophobic or superhydrophobic paint having a color selected based on the application (e.g., defense radome system for U.S. Navy installation).

In the embodiment of FIG. 2A, topcoat 24A also includes nanoparticles 26A. Nanoparticles 26A can be formed from an iron oxide (e.g., magnetite—Fe₃O₄) with paramagnetic properties such that nanoparticles 26A can generate heat within topcoat 24A when subjected to RF radiation as is discussed in greater detail below. In an alternative embodiment, nanoparticles 26 can be formed from other carbon-based (e.g., carbon black, carbon nanotubes, graphene) or metal-based nanomaterials with RF heating capability such as gold. Nanoparticles 26A can vary in material type, geometry, aspect ratio and/or particle size. Average particle size can generally range from 1 nanometer to 500 nanometers, while in some embodiments, range from 10 nanometers to 20 nanometers, and in other embodiments, range from 100 nanometers to 200 nanometers. The nanoparticle loading, size, and surface chemistry of nanoparticles 26A can be selected to minimize agglomeration of nanoparticles 26A and promote uniform distribution of nanoparticles 26A in topcoat 24A. Surfactants and dispersing agents can also be used to promote uniform distribution of nanoparticles 26A. In one embodiment, material type and/or particle size distribution can be generally homogeneous, while in an alternative embodiment, material type and/or particle size distribution can be varied. With any embodiment, the nanoparticle characteristics should be optimized for uniform heat generation. The nanoparticle content of topcoat 24A can range from 0.05 percent by weight (wt %) to 5 wt %, and more specifically, from 0.1 wt % to 1.0 wt %. As discussed further herein, the content, distribution, and size of nanoparticles 26A can be selected to provide a sufficient heating capacity to reduce or prevent the formation of ice on radome 14A, while maintaining material properties of topcoat 24A, such as hydrophobicity, durability (e.g., environmental exposure to hail impact, snow and ice, sand and dust, salt fog, fungus, humidity, etc.), adhesion, transmission loss, corrosion resistance, and dielectric, and loss tangent, among other properties as may be required for radar performance.

During operation of system 10, one or more instruments 12 associated with radomes 14A transmit RF signal emanations 16. The materials of substrate 20A and coating arrangement 18A, including nanoparticles 26A, are minimally absorbing to RF signal emanations in the operational band such that they do not interfere with RF signal emanations 16. However, exposure to RF signal emanations 16 induces localized heating of nanoparticles 26A, and thereby topcoat 24A. The heat generated by nanoparticles 26A can increase a surface temperature of topcoat 24A to reduce or prevent the formation of ice on radome 14A. An increase in surface temperature of approximately or at least 2° C. can be sufficient to form a layer of water at the outer surface of topcoat 24A, which can prevent ice from adhering to topcoat 24A. Further, the heating function of nanoparticles 26A requires no additional stimulus (e.g., applied form of energy) beyond RF signal emanations 16, and is therefore incidental to the normal operation of system 10. Nanoparticles 26A can be evenly dispersed and distributed through topcoat 24A to produce even heating of radome 14A. The content, distribution, and size of nanoparticles 26A can be selected to provide a desired temperature increase (e.g., 2° C.) at the outer surface of topcoat 24A to reduce or prevent the formation of ice on radome 14A.

FIG. 2B illustrates substrate 20B coated with coating arrangement 18B. Substrate 20B can be substantially similar to substrate 20A of FIG. 2A. Coating arrangement 18B includes primer 22B applied to substrate 20B and topcoat 24B applied to primer 22B. Primer 22B and topcoat 24B are substantially similar to primer 22A and topcoat 24A, except that in coating arrangement 18B, nanoparticles 26B are instead incorporated into primer 22B. Nanoparticles 26B can be substantially similar to nanoparticles 26A with respect to material, particles size, content, and mechanism of generating heat. The embodiment of FIG. 2B may be preferred in systems where color change within the topcoat is not desirable, as heat generation of nanoparticles embedded in the topcoat (i.e., topcoat 20A) has been experimentally observed to alter (e.g., darken) the topcoat based on the color of the coating and the nanoparticle base material color and/or nanoparticle content. Such applications include those in which the system should ideally visually blend in with its surroundings. Nanoparticles 26B can be evenly dispersed and distributed through primer 22B to produce even heating of radome 14B. The content, distribution, and size of nanoparticles 26B can be selected to provide a sufficient heating capacity to reduce or prevent the formation of ice on radome 14B, while maintaining material properties of coating arrangement 18B, such as hydrophobicity, durability, adhesion, transmission loss, dielectric, loss tangent, corrosion resistance, among other properties as may be required for radar performance.

FIG. 2C illustrates substrate 20C coated with coating arrangement 18C. Substrate 20C can be substantially similar to substrate 20A and 20B of FIGS. 2A and 2B, respectively. Coating arrangement 18C includes first coating layer 24C-1 and second coating layer 24C-2. First coating layer 24C-1 can be substantially similar to topcoat 24A of FIG. 2A. Second coating layer can be substantially similar to topcoat 24B of FIG. 2B. First coating layer 24C-1 and second coating layer 24C-2 can have the same topcoat material composition with the exception that first coating layer 24C-1 includes nanoparticles 26C. In contrast to coating arrangements 18A and 18B, the topcoat material (first coating layer 24C-1) is applied directly to substrate 20C without a primer (e.g., primer 22A of FIG. 1). Coating arrangement 18C can be preferred in applications in which a primer is not necessary for bonding the topcoat material (first coating layer 24C-1) to substrate 20C. As discussed further herein, second coating layer 24C-2 can conceal any color changes to first coating layer 24C-1 caused by nanoparticles 26C and can protect first coating layer 24C-1. Damage to second coating layer 24C-2 can be repaired or reworked as necessary.

Nanoparticles 26C can be substantially similar to nanoparticles 26A with respect to material, particle size, content, and mechanism of generating heat. In some examples, the addition of nanoparticles 26C to first coating layer 24C-1 can alter the color of (e.g., darken) first coating layer 24C-1, such that first coating layer 24C-1 and second coating layer 24C-2 are different in color. The application of second coating layer 24C-2 over first coating layer 24C-1 can visually conceal first coating layer 24C-1 and thereby define the color of the article (e.g., radome 14). The color of second coating layer 24C-2 can be selected based on the application as previously discussed. The content, particle size, and distribution of nanoparticles 26C in first coating layer 24C-1 can be selected so as to not inhibit curing/drying of first coating layer 24C-1 and to provide no or negligible change to viscosity of the coating material of first coating layer 24C-1, such that both first coating layer 24C-1 and second coating layer 24C-2 can be spray coated to a dry thickness of less than 0.254 mm (10 mil). Furthermore, the content, particle size, and distribution of nanoparticles 26C in first coating layer 24C-1 can be selected to provide no or negligible change to the hydrophobicity, durability, adhesion, corrosion resistance, transmission loss, dielectric, and loss tangent, among other required material properties, of coating arrangement 18C.

A hydrophobic surface can be required to ensure water, snow, and ice do not accumulate on radome 14 and cause signal degradation. Coating arrangement 18C and, particularly, second coating layer 24C-2, can have contact or wetting angles greater than 120 degrees (ASTM C813).

First coating layer 24C-1 can have an adhesion substantially the same as second coating layer 24C-2, as determined, for example, by wet tape test (ASTM D3330) or cross-hatch adhesion test. In this context, substantially the same is indicated by the absence of bared spots in the wet tape test for each of first coating layer 24C-1 and second coating layer 24C-2.

First coating layer 24C-1 can have a negligible impact on the durability of coating arrangement 18C as well as weathering performance as determined with Unites States military standard MIL-STD-810. First coating layer 24C-1 can have a transmission loss approximately equal to or substantially similar to second coating layer 24C-2, as determined by waveguide testing. First coating layer 24C-1 can have a dielectric and loss tangent approximately equal to or substantially similar to second coating layer 24C-2, as determined by waveguide testing.

Furthermore, the heat generated by nanoparticles 26C has no or negligible impact on the color, hydrophobicity, adhesion, durability, corrosion resistance, transmission loss, dielectric, and loss tangent, among other required properties of coating assembly 18C, including first coating layer 24C-1 and second coating layer 24C-2.

Coating arrangement 18C, including first coating layer 24C-1 and second coating layer 24C-2, has a thickness extending from substrate 20C of less than 10 mils (0.254 mm) and, preferably, around 5 mils (0.127 mm). As previously described, the content, distribution, and size of nanoparticles 26C can be selected to provide a temperature increase (e.g., 2° C.) at the outer surface of second coating layer 24C-2 to reduce or prevent the formation of ice on radome 14A.

Coating arrangements 18A-18C can be applied to respective substrates 20A-20C using a spray coating technique in an exemplary embodiment. With respect to coating arrangement 18A, primer 22A can be applied to substrate 20A via spray coating and allowed to cure. Nanoparticles 26A can be added to the organic polymer material of topcoat 24A as a dry nanopowder or dispersed in solution, forming a stable liquid suspension which can be applied to primer 22A via spray coating. To facilitate particle dispersion within topcoat 24A, various additives (e.g., solvents, surfactants, and/or dispersants) can be included in the suspension. Nanoparticles 26A can additionally and/or alternatively be functionalized to facilitate dispersion. Mechanical means, such as an agitator in the spraying apparatus can additionally and/or alternatively be used. Coating 18C can be similarly applied, except for topcoat 24A would be applied directed to substrate 20C as first coating layer 24C-1 and allowed to cure and second coating layer 24C-2 (topcoat material without nanoparticles 26C) would be applied over first coating layer 24C-1. Coating arrangement 18B can be similarly applied, except that nanoparticles 26B would be mixed with the epoxy of primer 22B, along with any solvents, surfactants, and/or dispersants. In an alternative embodiment, coating arrangements 18A, 18B, and/or 18C can be applied to respective substrates 20A, 20B, and 20C using a painting or dip coating technique. It should be noted that the incorporation of nanoparticles and/or additives within the disclosed coating arrangements does not impact adhesion between the primer to the substrate, nor the adhesion of the topcoat to the primer, nor adhesion between the topcoat material (as provided in first coating layer 24C-1) to the substrate.

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transient alignment or shape variations induced by thermal, rotational or vibrational operational conditions, and the like. Moreover, any relative terms or terms of degree used herein should be interpreted to encompass a range that expressly includes the designated quality, characteristic, parameter or value, without variation, as if no qualifying relative term or term of degree were utilized in the given disclosure or recitation.

### Discussion of Possible Embodiments

The following are non-exclusive descriptions of possible embodiments of the present invention.

A radome surface coating arrangement transparent to radiofrequency (RF) signals includes a first coating layer applied to and in physical contact with a radome surface and a second coating layer applied to and in physical contact with the first coating layer. The first coating layer includes nanoparticles capable of being heated by RF signals emitted through the coating arrangement and the second coating layer includes a hydrophobic or superhydrophobic coating material and is devoid of the nanoparticles. The second coating layer covers the first coating layer.

The radome surface coating arrangement of the preceding paragraph can optionally include, additionally and/or alternatively, any one or more of the following features, configurations and/or additional components:

In the above radome surface coating arrangement, the first coating layer can include the hydrophobic or superhydrophobic coating material of the second coating layer and the nanoparticles are dispersed throughout the hydrophobic or superhydrophobic coating material.

In any of the above radome surface coating arrangements, the hydrophobic or superhydrophobic coating material can be a paint and the first coating layer can be a first color and the second coating layer can be a second color different from the first color.

In any of the above radome surface coating arrangements, the first coating layer and the second coating layer together can have a combined thickness extending from the substrate of less than 10 mils (0.254 mm).

In any of the above radome surface coating arrangements, an average size of the nanoparticles can range from 1 nanometer to 500 nanometers.

In any of the above radome surface coating arrangements, a content of the nanoparticles can range from 0.05 wt % to 5 wt %.

In any of the above radome surface coating arrangements, the content of the nanoparticles can range from 0.1 wt % to 1.0 wt %.

In any of the above radome surface coating arrangements, the nanoparticles can be formed from carbon-based or metal-based nanoparticles.

In any of the above radome surface coating arrangements, the nanoparticles can be iron oxide.

In any of the above radome surface coating arrangements, the first coating layer can be configured to raise an outer surface temperature of the second coating layer by at least two degrees Celsius upon exposure to RF signals emitted through the coating arrangement.

In any of the above radome surface coating arrangements, the radome surface can be formed from a composite material.

In one embodiment, a system includes a radome formed from a composite material; any of the above surface coating arrangements disposed on a surface of the radome, and an RF-emitting instrument configured to emit RF signals through the radome and surface coating arrangement.

A method of preventing ice formation on a radome includes providing a coating arrangement to a surface of the radome and operating an instrument at least partially surrounded by the radome to emit RF signals such that the heating of the nanoparticles is induced by the RF signals. The coating arrangement includes a first coating layer applied to and in physical contact with the surface and a second coating layer applied to and in physical contact with the first coating layer. The first coating layer includes nanoparticles capable of being heated by RF signals emitted through the radome. The second coating layer includes a hydrophobic or superhydrophobic coating material devoid of the nanoparticles. The second coating layer covers the first coating layer.

The method of the preceding paragraph can optionally include, additionally and/or alternatively, any one or more of the following features, configurations and/or additional components:

In the above method, heating of the nanoparticles raises an outer surface temperature of the second coating layer by at least two degrees Celsius.

In any of the above methods, the nanoparticles are formed from carbon-based or metal-based nanoparticles.

In any of the above methods, the nanoparticles can be formed from iron oxide.

In any of the above methods, the first coating layer can include the hydrophobic or superhydrophobic coating material of the second coating layer and wherein the nanoparticles are dispersed throughout the hydrophobic or superhydrophobic coating material.

An article transparent to radiofrequency (RF) signals includes a substrate and a coating arrangement on the substrate. The coating arrangement includes a primer applied to and in physical contact with the substrate, a topcoat applied to and in physical contact with the primer layer, the topcoat including an organic polymer material, and nanoparticles dispersed throughout one of the primer and the topcoat. A content of the nanoparticles ranges from 0.1 wt % to 10 wt %.

The article of the preceding paragraph can optionally include, additionally and/or alternatively, any one or more of the following features, configurations and/or additional components:

In the above article, an average size of the nanoparticles can range from 1 nanometers to 500 nanometers.

In any of the above articles, the primer can include epoxy or urethane.

In any of the above articles, the organic polymer material of the topcoat can be hydrophobic or superhydrophobic.

In any of the above articles, the content of the nanoparticles can range from 0.1 wt % to 1.0 wt %.

In any of the above articles, the nanoparticles can be dispersed throughout the topcoat.

In any of the above articles, the nanoparticles can be dispersed throughout the primer.

In any of the above articles, the nanoparticles can be formed from iron oxide or gold.

In any of the above articles, the substrate can be formed from a composite.

In any of the above articles, the article can be a radome.

A system includes the above radome, and an RF-emitting instrument.

A method of preventing ice formation on a radome includes applying a coating arrangement to a surface of the radome. The coating arrangement includes a primer applied to and in physical contact with the surface of the radome, a topcoat applied to and in physical contact with the primer layer, the topcoat including an organic polymer material, and nanoparticles dispersed throughout one of the primer and the topcoat. The method further includes operating an instrument at least partially surrounded by the radome to emit radiofrequency (RF) signals such that the heating of the nanoparticles is induced by the RF signals.

The method of the preceding paragraph can optionally include, additionally and/or alternatively, any one or more of the following features, configurations and/or additional components:

In the above method, the nanoparticles can be dispersed throughout the topcoat.

In any of the above methods, the step of applying the coating arrangement can include applying the primer to the surface of the radome, and subsequently, applying the topcoat with the nanoparticles to the primer.

In any of the above methods, the nanoparticles can be dispersed throughout the primer.

In any of the above methods, the step of applying the coating arrangement can include

In any of the above methods, applying the primer with the nanoparticles to the surface of the radome, and

In any of the above methods, subsequently, applying the topcoat to the primer.

In any of the above methods, a content of the nanoparticles can range from 0.05 wt % to 5 wt %

In any of the above methods, the content of the nanoparticles can range from 0.1 wt % to 1.0 wt %.

In any of the above methods, the nanoparticles can be formed from iron oxide or gold.

In any of the above methods, an average size of the nanoparticles can range from 1 nanometers to 500 nanometers.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A radome surface coating arrangement transparent to radiofrequency (RF) signals, the coating arrangement comprising:
a first coating layer applied to and in physical contact with a radome surface, the first coating layer comprising nanoparticles capable of being heated by RF signals emitted through the coating arrangement; and
a second coating layer applied to and in physical contact with the first coating layer, the second coating layer comprising a hydrophobic or superhydrophobic coating material, wherein the second coating layer is devoid of the nanoparticles;
wherein the second coating layer covers the first coating layer.

2. The radome surface coating arrangement of claim 1, wherein the first coating layer comprises the hydrophobic or superhydrophobic coating material of the second coating layer and wherein the nanoparticles are dispersed throughout the hydrophobic or superhydrophobic coating material.

3. The radome surface coating arrangement of claim 1, wherein the hydrophobic or superhydrophobic coating material is a paint and wherein the first coating layer is a first color and the second coating layer is a second color different from the first color.

4. The radome surface coating arrangement of claim 1, wherein the first coating layer and the second coating layer together have a combined thickness extending from the substrate of less than 10 mils (0.254 mm).

5. The radome surface coating arrangement of claim 1, wherein an average size of the nanoparticles ranges from 1 nanometers to 500 nanometers.

6. The radome surface coating arrangement of claim 1, wherein a content of the nanoparticles ranges from 0.05 wt % to 5 wt %.

7. The radome surface coating arrangement of claim 1, wherein the content of the nanoparticles ranges from 0.1 wt % to 1.0 wt %.

8. The radome surface coating arrangement of claim 1, wherein the nanoparticles are formed from carbon-based or metal-based nanoparticles.

9. The radome surface coating arrangement of claim 1, wherein the nanoparticles are iron oxide.

10. The radome surface coating arrangement of claim 1, wherein the first coating layer is configured to raise an outer surface temperature of the second coating layer by at least two degrees Celsius upon exposure to RF signals emitted through the coating arrangement.

11. The radome surface coating arrangement of claim 1, wherein the radome surface is formed from a composite material.

12. A system comprising:
a radome formed from a composite material;
the surface coating arrangement of claim 1 disposed on a surface of the radome; and
an RF-emitting instrument configured to emit RF signals through the radome and surface coating arrangement.

13. A method of preventing ice formation on a radome, the method comprising:
applying a coating arrangement to a surface of the radome, the coating arrangement comprising:
a first coating layer applied to and in physical contact with the surface, the first coating layer comprising nanoparticles capable of being heated by RF signals emitted through the radome; and
a second coating layer applied to and in physical contact with the first coating layer, the second coating layer comprising a hydrophobic or superhydrophobic coating material, wherein the second coating layer is devoid of the nanoparticles and covers the first coating layer; and
operating an instrument at least partially surrounded by the radome to emit RF signals such that the heating of the nanoparticles is induced by the RF signals.

14. The method of claim 13, wherein heating of the nanoparticles raises an outer surface temperature of the second coating layer by at least two degrees Celsius.

15. The method of claim 13, wherein the nanoparticles are formed from carbon-based or metal-based nanoparticles.

16. The method of claim 13, wherein the nanoparticles are formed from iron oxide.

17. The method of claim 13, wherein the first coating layer comprises the hydrophobic or superhydrophobic coating material of the second coating layer and wherein the nanoparticles are dispersed throughout the hydrophobic or superhydrophobic coating material.
